(19) United States
(12) Patent Application Publication
(10) Pub. No.: US 2005/0263096 A1
(43) Pub. Date: Dec. 1, 2005

(54) Pet furniture system

(76) Inventors: Frank P. Mita, Wayne, PA (US); Jerry L. Kohli, Simsbury, CT (US)

Correspondence Address: RATNERPRESTIA, P O BOX 980, VALLEY FORGE, PA, 19482-0980, US

(21) Appl. No.: 10/843,907

(22) Filed: May 12, 2004

(51) Int. Cl. A01K 15/02

(52) U.S. Cl. 119/706

(57) ABSTRACT

A pet furniture system includes a base and a column configured to be coupled to the base. The column includes a plurality of wall sections adaptable to be folded to assemble the column, and adaptable to be unfolded to disassemble the column. The pet furniture system also includes a cover for at least partially covering the column. The cover is configured for repeated removal from, and covering of, said column.

### FIELD OF THE INVENTION

This present invention relates to pet furniture, and more particularly, to collapsible pet furniture.

### BACKGROUND OF THE INVENTION

Consumers that own pets often purchase pet furniture to improve the quality of life of their pet. For example, with respect to consumers who own cats, such furniture includes scratching posts, cat beds, and cat dwellings. This type of pet furniture provides a number of useful benefits to the consumer. For example, by providing furniture for a pet to scratch, bite, and paw, the consumer may substantially reduce damage and/or wear on other household furniture and carpeting. Additionally, such pet furniture may occupy the attention of a pet such that the pet does not become bored. Further still, such pet furniture may provide a private space for a pet to rest, sleep, etc.

Unfortunately, such pet furniture is typically quite large and consequently difficult to store and ship. The furniture is typically assembled prior to arrival at a retail store, where the assembled furniture often includes a heavy-duty cardboard covered with a carpeting material.

After being purchased by a consumer, the pet furniture may become worn, soiled, etc. For example, food, urine, and/or other substances may soil the carpeting material. Because there is no convenient way to clean the carpeting material, consumers often wastefully dispose of the furniture after it has become soiled.

Additionally, after a certain period of time, a pet may become bored with the same piece of furniture, and as such, a consumer may purchase a different piece of furniture (and consequently wastefully discard the older piece of furniture) in order to captivate the interest of the pet.

Another problem with conventional pet furniture is that pet hair (and associated pet dander and the like) may become deposited on pet furniture after continued use. As discussed in U.S. Pat. No. 6,481,383, pet hair may result in excessive housework, stress, and allergic reactions in some people. Attempts to clean pet hair from conventional pet furniture (e.g., vacuuming, brushing, etc.) often involves excessive effort by the pet owner, and may yield marginal results.

Thus, it would be desirable to provide pet furniture overcoming one or more of the above-described deficiencies.

### SUMMARY OF THE INVENTION

According to an exemplary embodiment of the present invention, a pet furniture system is provided. The pet furniture system includes a base and a column configured to be coupled to the base. The column includes a plurality of wall sections adaptable to be folded to assemble the column, and adaptable to be unfolded to disassemble the column. The pet furniture system also includes a cover for at least partially covering the column. The cover is configured for repeated removal from, and covering of, the column.

According to another exemplary embodiment of the present invention, a method of assembling a pet furniture system is provided. The method includes providing a base of the pet furniture system. The method also includes assembling a column configured to be coupled to the base by folding a plurality of wall sections of the column to a predetermined shape. The method also includes coupling the column to the base. The method also includes covering at least a portion of the column with a cover, where the cover is configured for repeated removal from, and covering of, the column.

### BRIEF DESCRIPTION OF THE DRAWINGS

Exemplary embodiments of the invention will be described with reference to the drawings, of which:

FIGS. 1A-H are perspective views illustrating assembly of a pet furniture system in accordance with an exemplary embodiment of the present invention;

FIGS. 2A-G are perspective views illustrating assembly of another pet furniture system in accordance with another exemplary embodiment of the present invention;

FIGS. 3A-I are perspective views illustrating assembly of yet another pet furniture system in accordance with yet another exemplary embodiment of the present invention;

FIG. 4A is a top view of a portion of a clasp system for use with pet furniture in accordance with an exemplary embodiment of the present invention;

FIG. 4B is a side view of a clasp system including the portion illustrated in FIG. 4A;

FIG. 4C is a top view of the clasp system illustrated in FIG. 4B; and

FIG. 5 is a flow diagram illustrating a method of assembling a pet furniture system in accordance with an exemplary embodiment of the present invention.

### DETAILED DESCRIPTION OF THE INVENTION

Preferred features of embodiments of this invention will now be described with reference to the figures. It will be appreciated that the spirit and scope of the invention is not limited to the embodiments selected for illustration. Also, it should be noted that the drawings are not rendered to any particular scale or proportion. It is contemplated that any of the configurations and materials described hereafter can be modified within the scope of this invention.

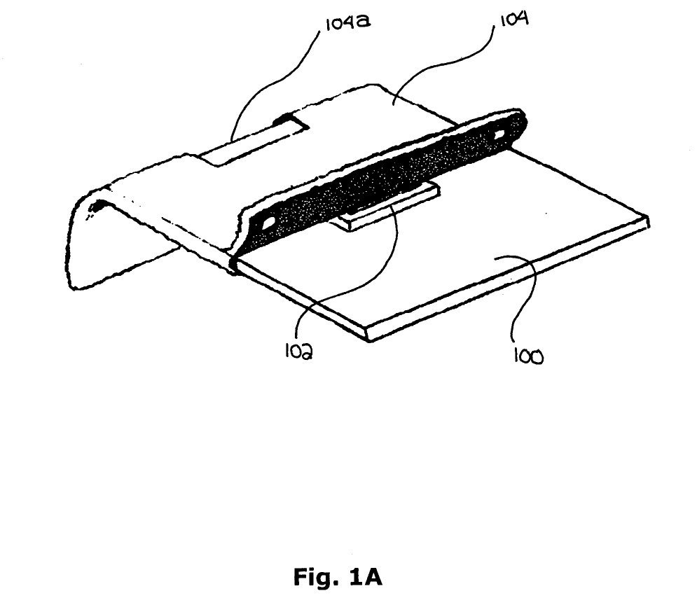

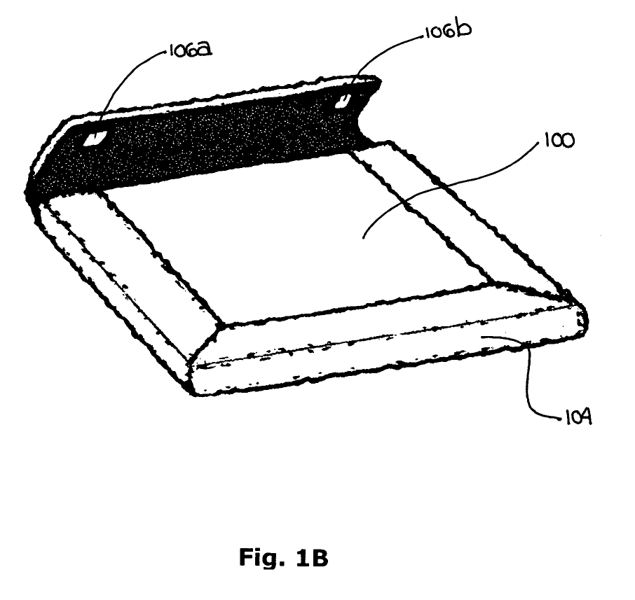

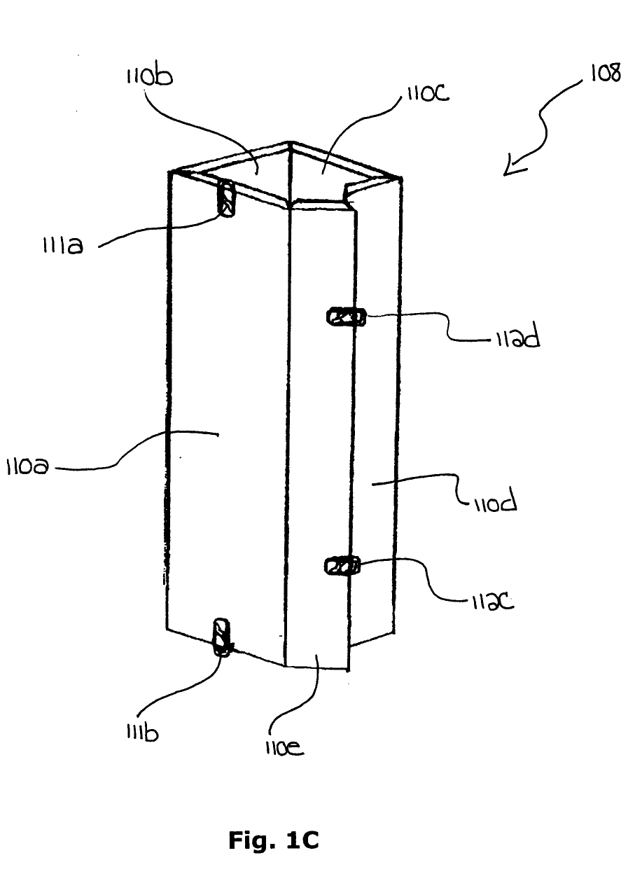

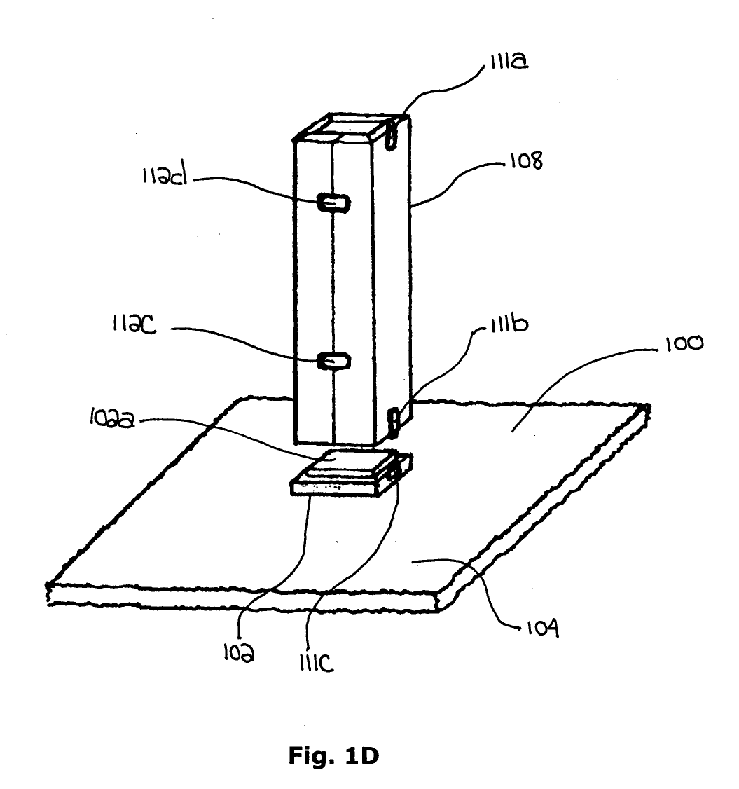

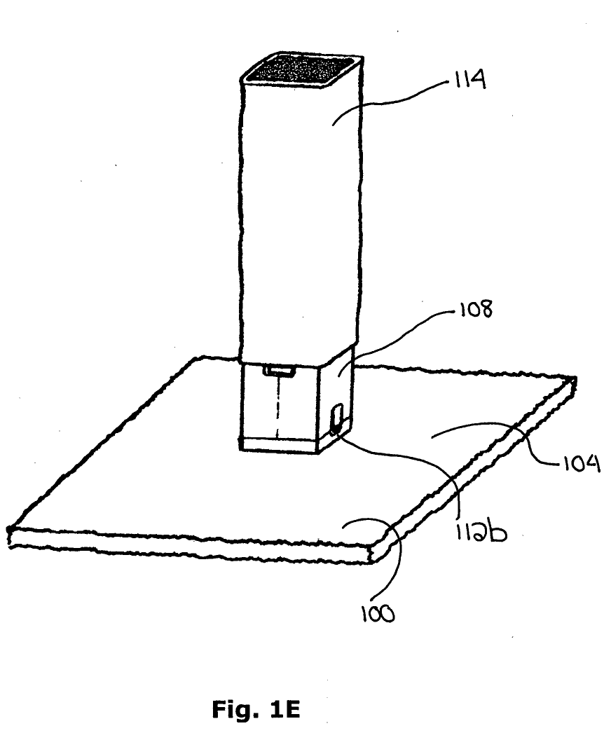

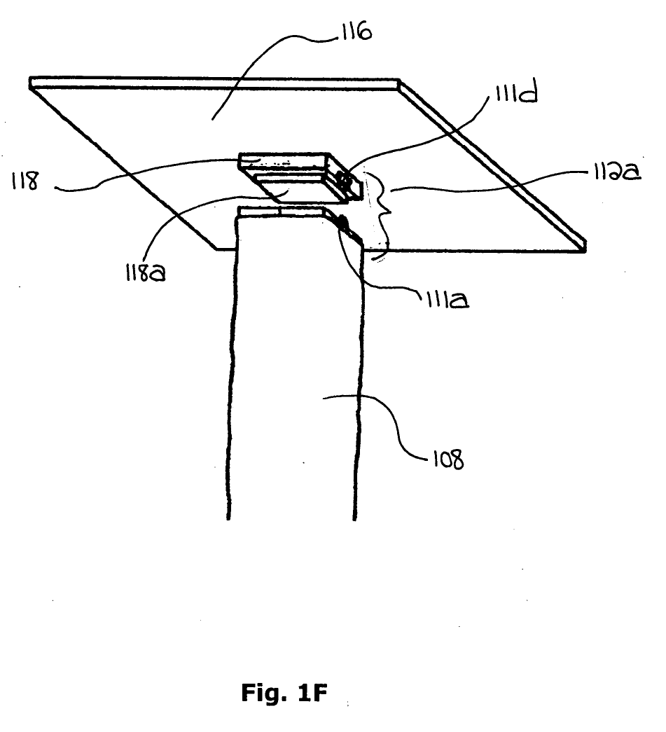

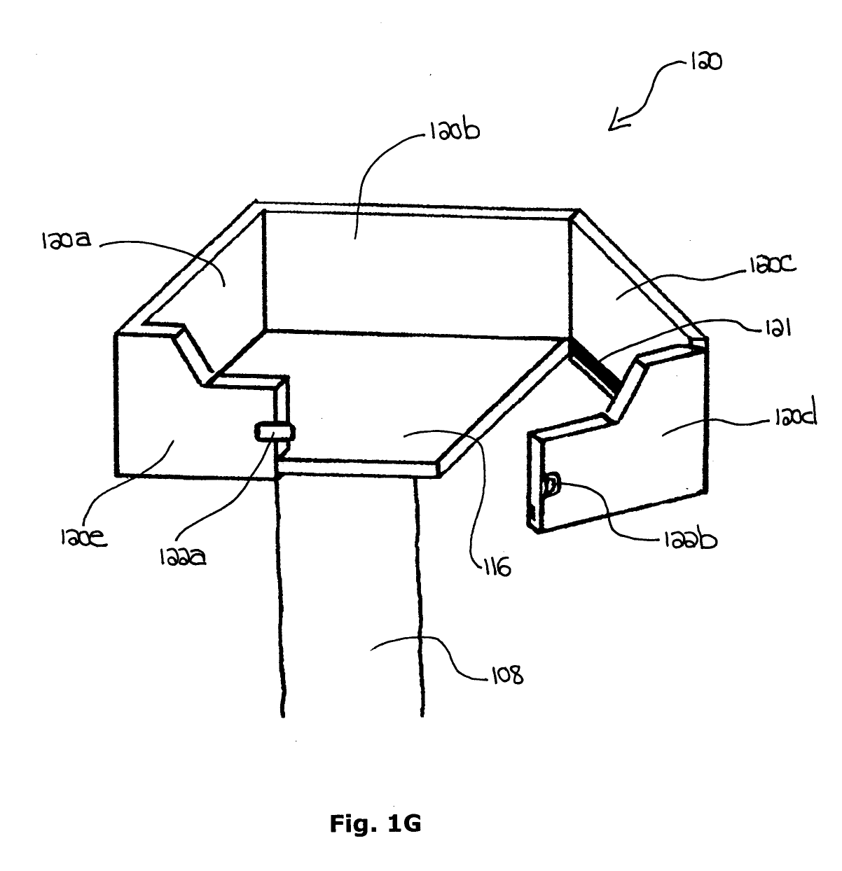

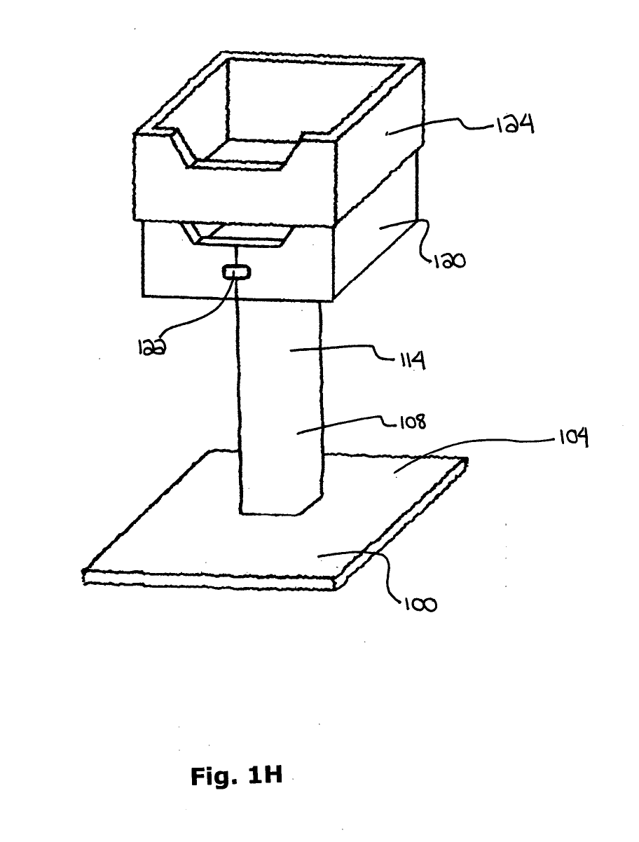

FIG. 1A is a perspective view illustrating base 100 of a pet furniture system. Column block 102 (which may be either coupled to or integrated with base 100) is provided for supporting a column as will be described herein. Base cover 104 is pulled over base 100 such that column block 102 at least partially extends through hole 104a defined in base cover 104.

FIG. 1B illustrates base 100 (inverted in comparison to the view of FIG. 1A) after base cover 104 has been fully extended over base 100. Base cover 104 includes tabs 106a and 106b (e.g., Velcro® tabs) for securing base cover 104 to base 100. Other mechanisms for securing base cover 104 to base 100 are contemplated, for example, snap fasteners, ties, etc.

FIG. 1C is a perspective view of column 108. Column 108 includes a number of wall sections 110a, 110b, 110c, 110d, and 110e that are pivotally (or hingedly) coupled to one another. Wall sections 110a, 110b, 110c, 110d, and 110e may be coupled as a group of wall sections, for example, by applying (e.g., using an adhesive) a fabric to an outer surface of each of wall sections 110a, 110b, 110c, 110d, and 110e. Such a fabric substantially maintains a relative position of each of wall sections 110a, 110b, 110c, 110d, and 110e with respect to one another. Thus, column may be assembled by folding wall sections 110a, 110b, 110c, 110d, and 110e as shown in FIG. 1C, and may be disassembled such that wall sections 110a, 110b, 110c, 110d, and 110e are substantially flat. This substantially flat configuration provides for compact storage and/or shipment of column 108.

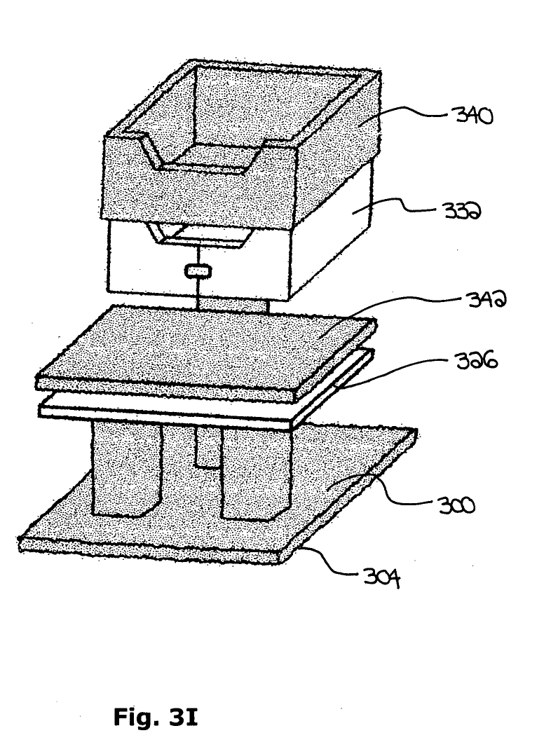

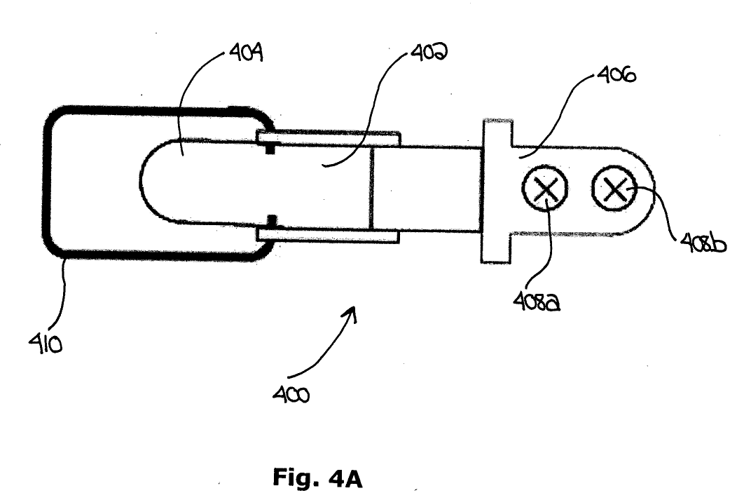

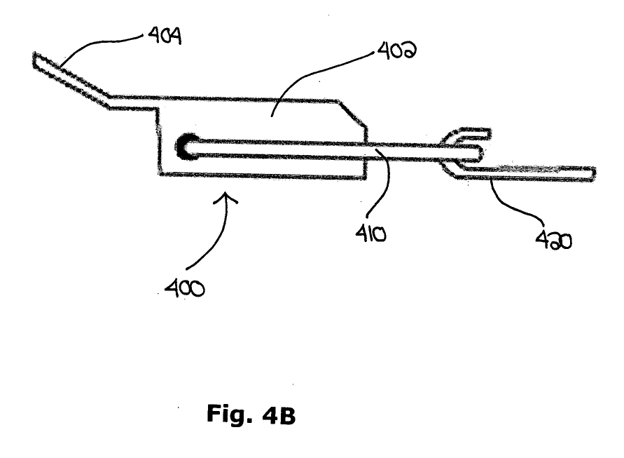

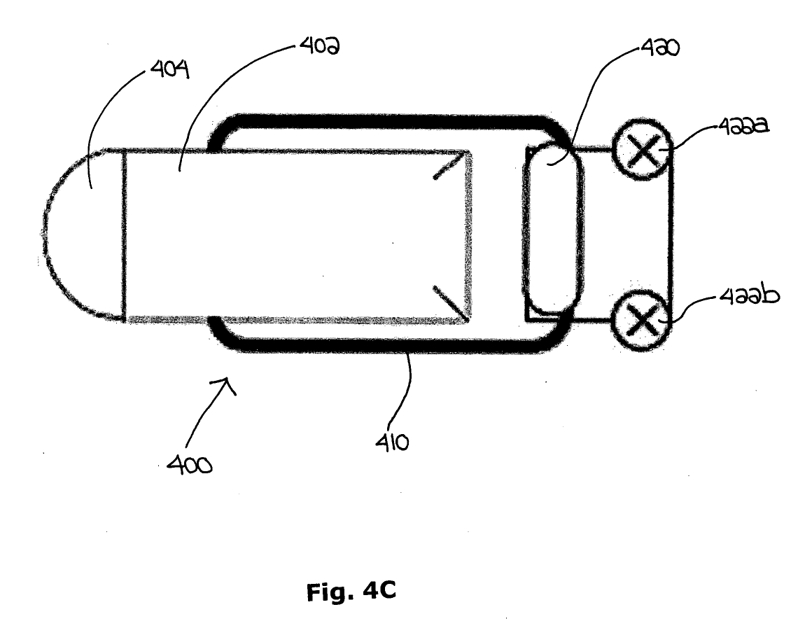

After folding wall sections 110a, 110b, 110c, 110d, and 110e as shown in FIG. 1C, column 108 may be further assembled by engaging a number of clasp systems 112c and 112d. As will be described in greater detail with respect to FIGS. 4A-4C, such clasp systems may include a loop portion and a hook portion, where the loop portion engages the hook portion. Column 108 also includes loop portions 111a and 111b of other clasp systems, the purpose of which will be described herein.

At FIG. 1D, column 108 is slid on to column block 102 of base 100 (which is covered by base cover 104). More specifically, column block 102 receives column 108, where raised portion 102a of column block 102 fits within an interior portion of column 108. Loop portion 111b of a clasp system is engaged with hook portion 111c of the same clasp system, thereby securing column 108 to base 100. Although not visible in FIG. 1D, another clasp system may be used on a side of column 108 opposite loop portion 111b, where this other clasp system includes a loop portion on column 108 and a corresponding hook portion on column block 102.

At FIG. 1E, cover 114 is pulled over column 108, and at FIG. 1F, bed base 116, including bed block 118, is coupled to an end of column 108 opposite the end of column 108 coupled to base 100. Bed block 118 includes raised portion 118a that fits within an interior portion of column 108. Further, loop portion 111a of clasp system 112a is engaged with hook portion 111d of clasp system 112a, thereby securing bed base 116 to column 108. Although not visible in FIG. 1F, another clasp system may be used on a side of column 108 opposite loop portion 111a, where this other clasp system includes a loop portion on column 108 and a corresponding hook portion on bed block 118.

FIG. 1G illustrates wall system 120 configured to be secured to pet bed base 116. Wall system 120 includes wall sections 120a, 120b, 120c, 120d, and 120e. Each of wall sections 120a, 120b, 120c, 120d, and 120e include a groove (e.g., groove 121 of wall section 120c) for accepting a corresponding portion of bed base 116, as illustrated in FIG. 1G. After each of the grooves of wall sections 120a, 120b, 120c, 120d, and 120e is properly aligned with a respective portion of bed base 116, loop portion 122a is engaged with hook portion 122b, thereby securing wall system 120 to pet bed base 116. Loop portion 122a and hook portion 122b are included in clasp system 122, as illustrated in FIG. 1H.

At FIG. 1H, bed cover 124 is applied (and secured, for example, using Velcro® tabs as described above) to wall system 120 and pet bed base 116.

Thus, as illustrated in FIGS. 1A-1H, a pet furniture system is provided that may be easily assembled and disassembled. When disassembled, the pet furniture system may be efficiently packaged for shipment and storage. For example, when unfolded (i.e., disassembled), each of column 108 and wall system 120 may be packaged in a compact form.

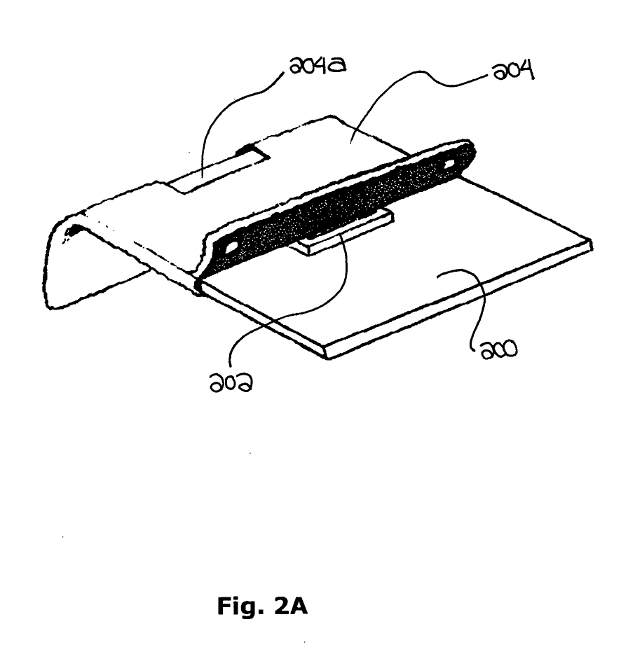

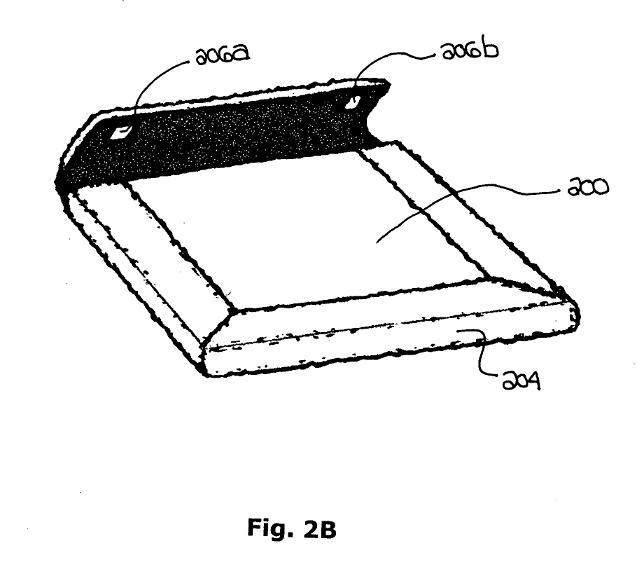

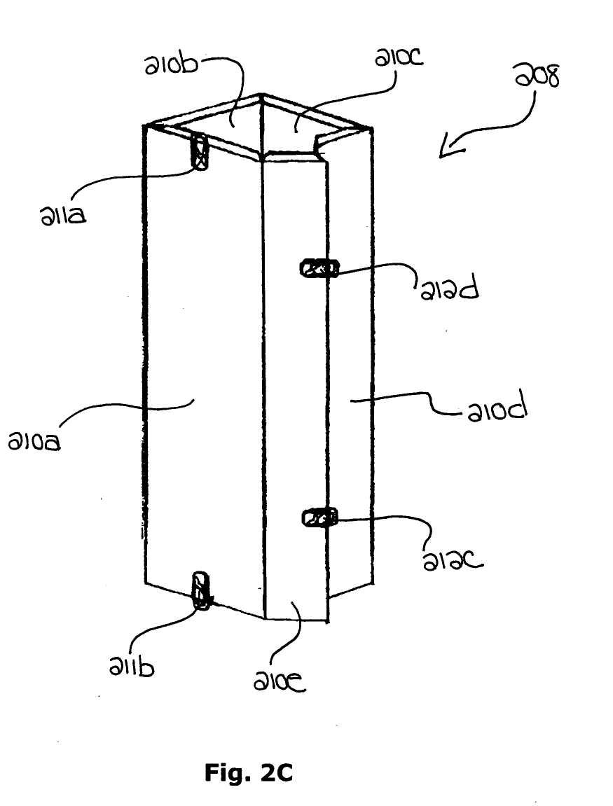

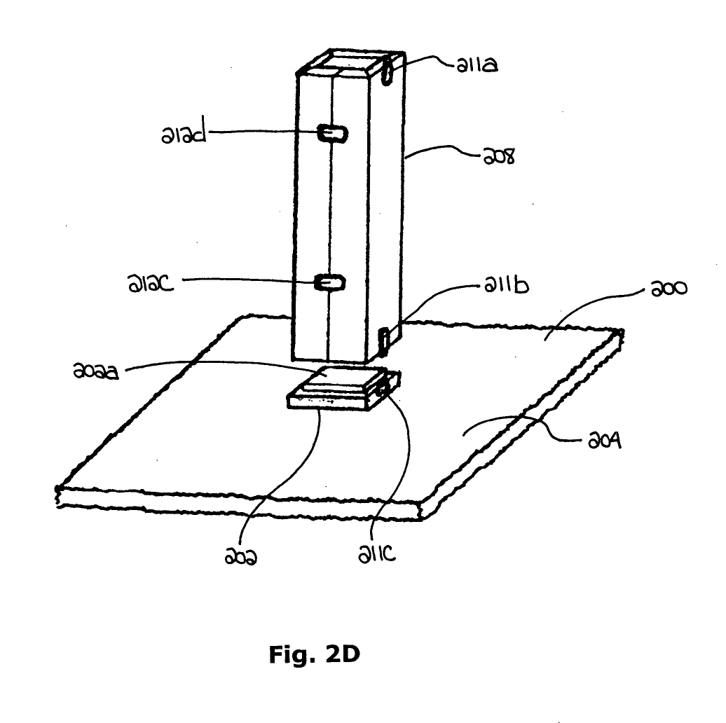

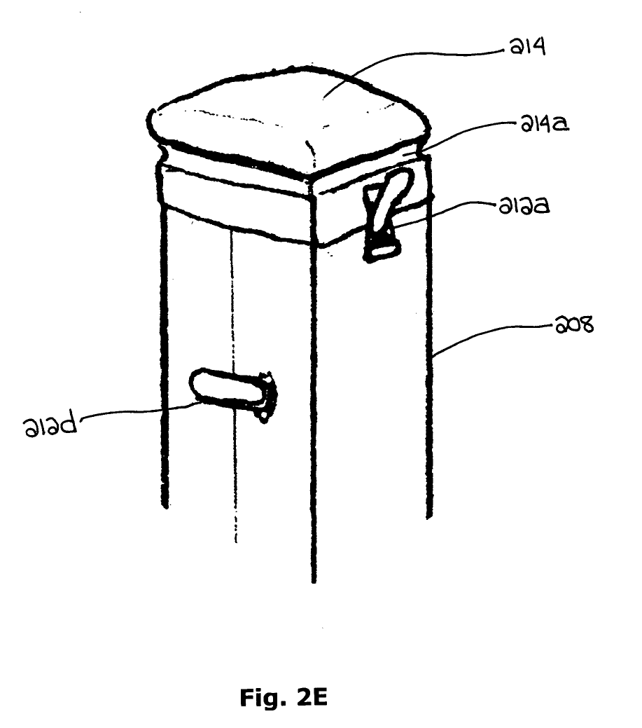

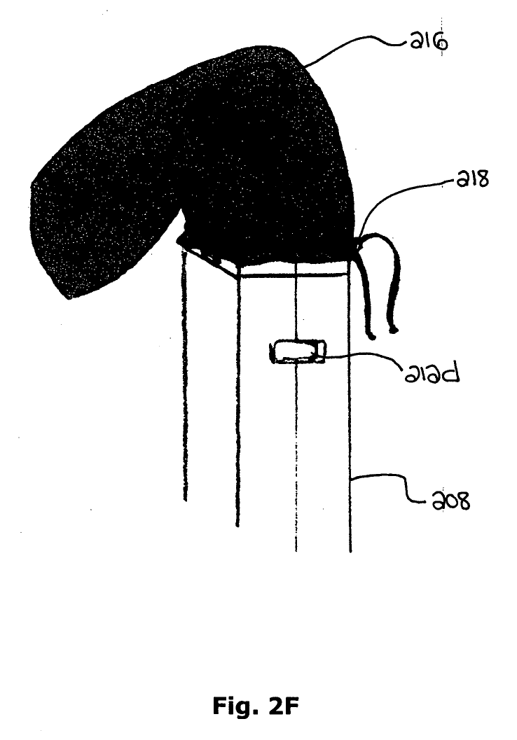

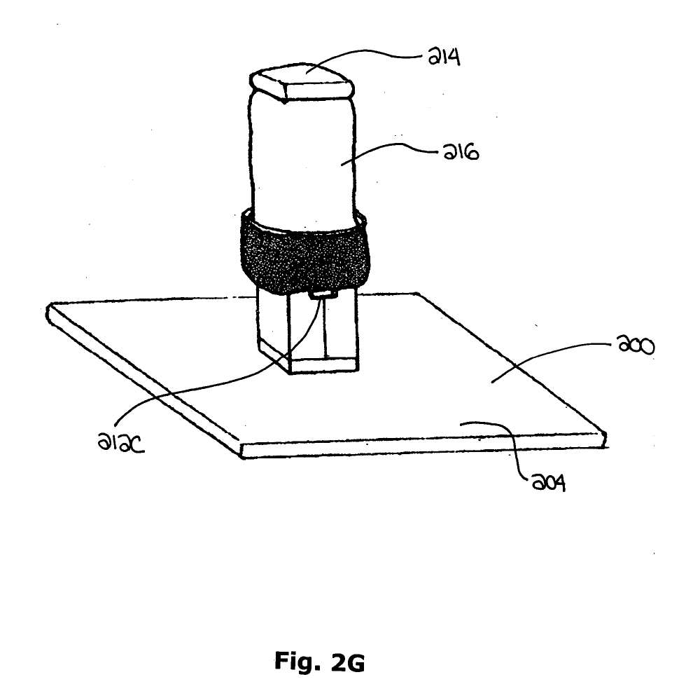

FIGS. 2A-2D are substantially similar to FIGS. 1A-1D with the exception of the different sequence of reference numerals. Thus, a separate description of FIGS. 2A-2D is omitted herein. At FIG. 2E, column cap 214 (e.g., a wood block) is coupled to, and substantially covers, an open end of column 208, and is secured thereto using clasp system 212a (where clasp system 212a includes loop portion 211a illustrated in FIG. 2D configured for engagement with a corresponding hook portion). As illustrated in FIG. 2E, column cap 214 defines groove 214a.

At FIG. 2F, an end portion of cover 216 is slipped over column cap 214 in an “inside-out” configuration. Tie 218 is secured to column cap 214 at groove 214a (groove 214a is illustrated in FIG. 2E). At FIG. 2G, post cover 216 is pulled over post 208.

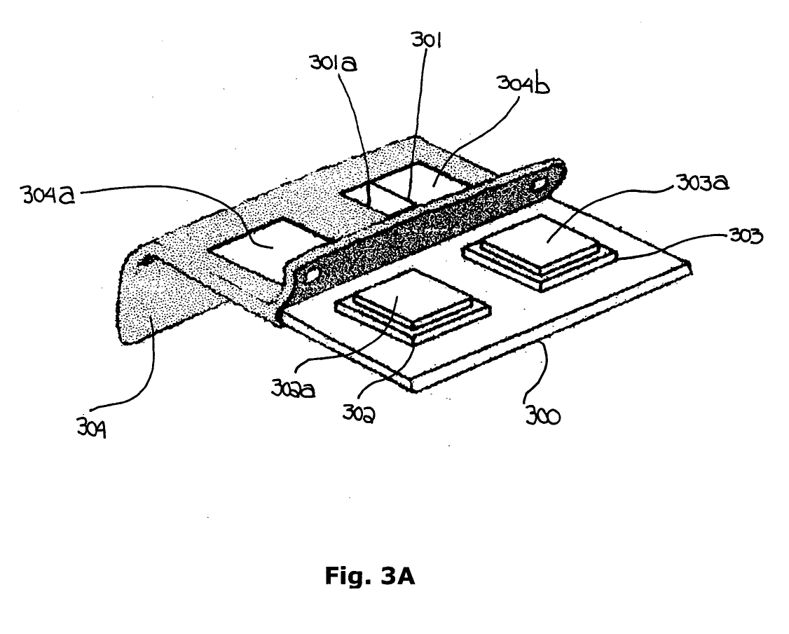

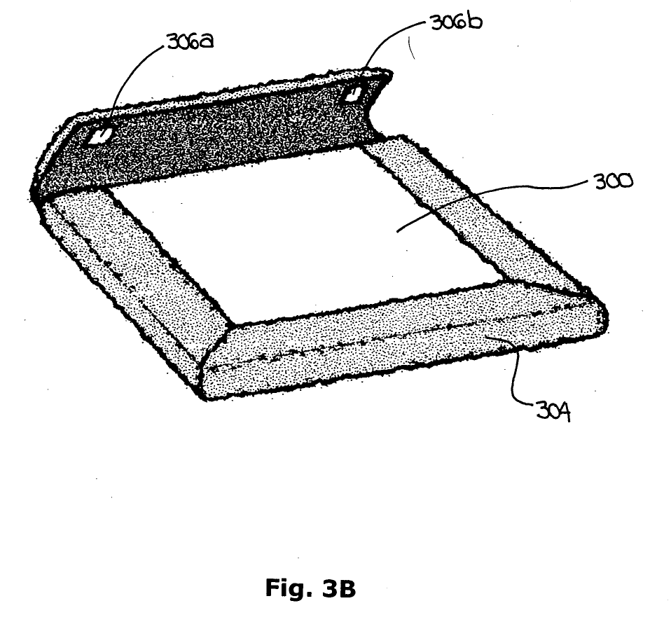

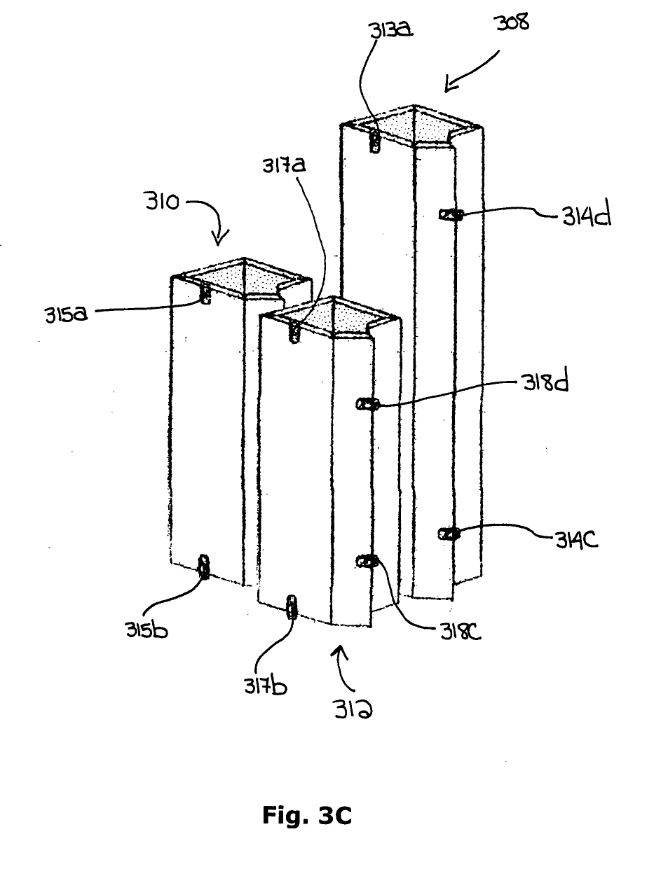

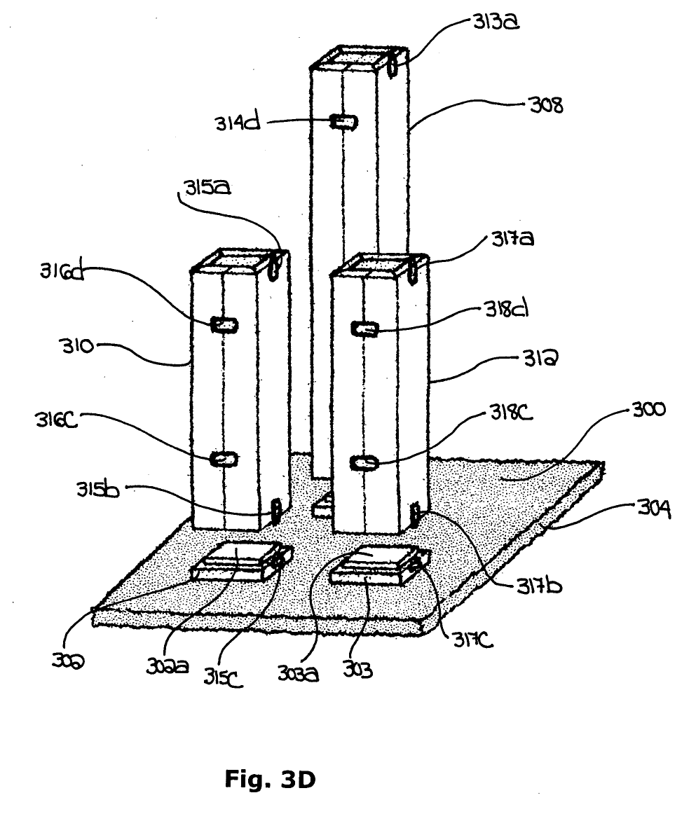

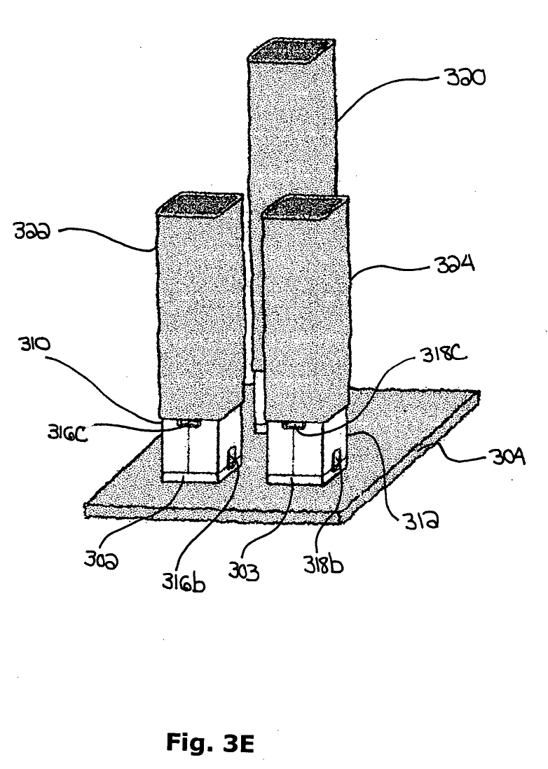

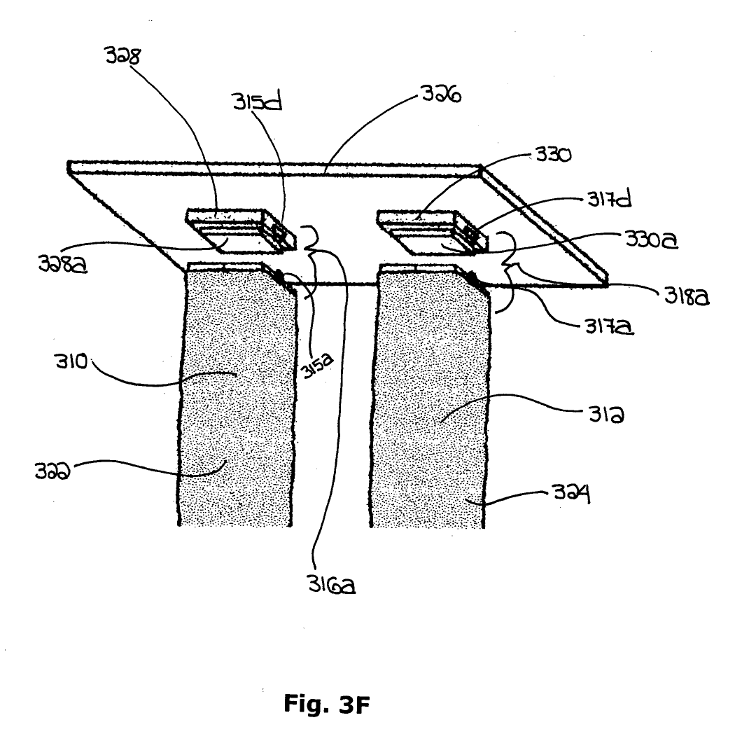

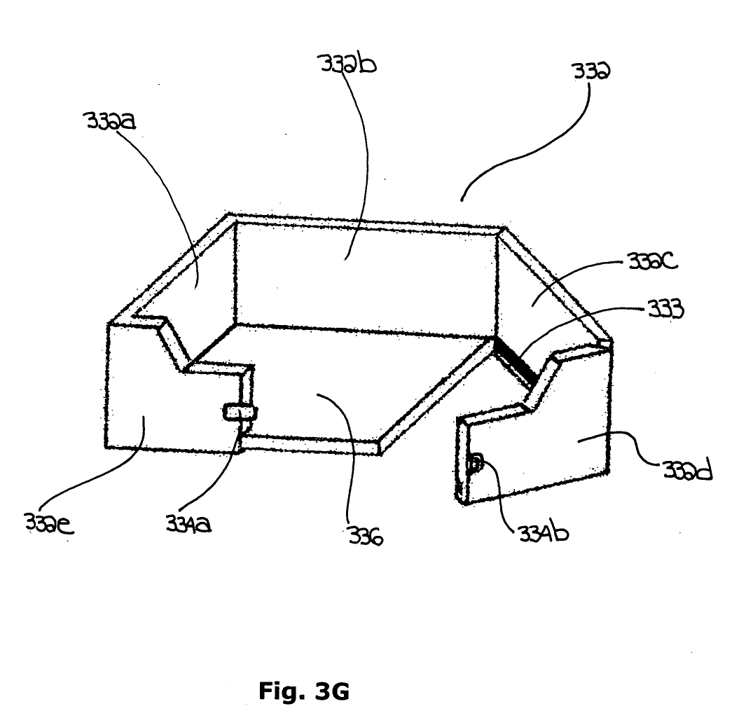

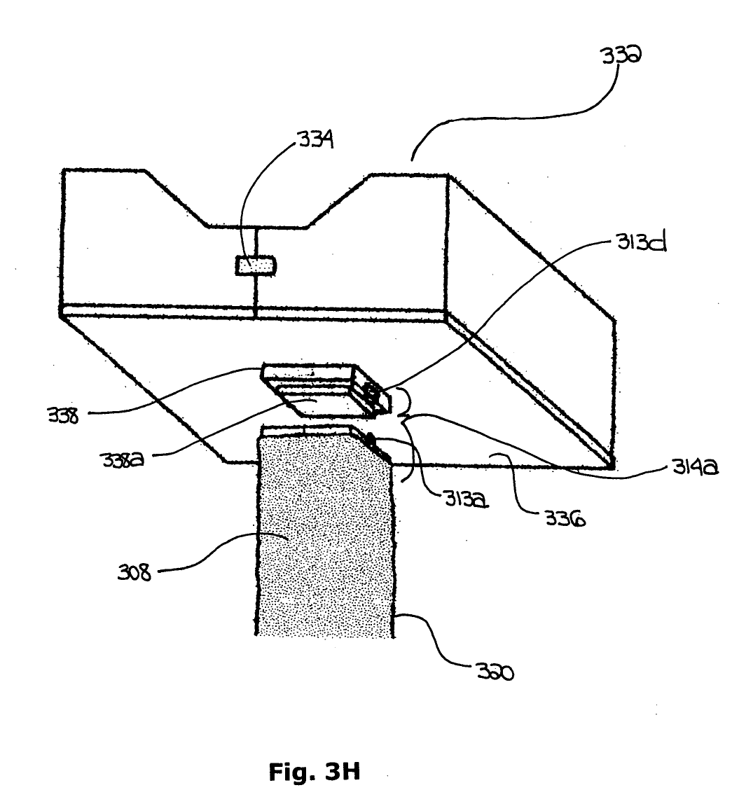

FIG. 3A illustrates base 300 of an exemplary pet furniture system. Base 300 includes column blocks 301 (including raised portion 301a), 302 (including raised portion 302a), and 303 (including raised portion 303a). As illustrated in FIG. 3A, base cover 304 is pulled over base 300 such that each of column blocks 301, 302, and 303 aligns with a respective hole (e.g., holes 304a, 304b, and 304c of which 304c is not visible in FIG. 3A) defined in base cover 304.

FIG. 3B illustrates base 300 (inverted in comparison to the view of FIG. 3A) after base cover 304 has been fully extended over base 300. Base cover 304 includes tabs 306a and 306b (e.g., Velcro® tabs) for securing base cover 304 to base 300.

FIG. 3C illustrates columns 308, 310, and 312. Column 308 includes clasp systems (each including a loop portion and a hook portion as described below in connection with FIGS. 4A-4C) 314c and 314d, as well as loop portions 313a and 313b of two additional clasp systems (loop portion 313b is not visible in FIG. 3C). Similarly, column 310 includes clasp systems (each including a loop portion and a hook portion) 316c and 316d (not visible in FIG. 3C), as well as loop portions 315a and 315b of two additional clasp systems. Further, column 312 includes clasp systems (each including a loop portion and a hook portion) 318c and 318d, as well as loop portions 317a and 317b of two additional clasp systems.

At FIG. 3D, each of assembled columns 308, 310, and 312 are slid on to a respective one of column blocks 301, 302, and 303 (column block 301 is not visible in FIG. 3D) of base 300 (which is covered by base cover 304). More specifically, column block 302 receives column 310, where raised portion 302a of column block 302 fits within an interior portion of column 310. Loop portion 315b of a clasp system is engaged with hook portion 315c of the same clasp system (i.e., clasp system 316b illustrated in FIG. 3E), thereby securing column 310 to base 300. Although not visible in FIG. 3D, another clasp system may be provided on a side of column 310 opposite loop portion 315b, where this other clasp system includes a loop portion on column 310 and a corresponding hook portion on column block 302.

Further, column block 303 receives column 312, where raised portion 303a of column block 303 fits within an interior portion of column 312. Loop portion 317b of a clasp system is engaged with hook portion 317c of the same clasp system (i.e., clasp system 318b illustrated in FIG. 3E), thereby securing column 312 to base 300. Although not visible in FIG. 3D, another clasp system may be provided on a side of column 312 opposite loop portion 317b, where this other clasp system includes a loop portion on column 312 and a corresponding hook portion on column block 303.

Further still, column block 301 (See FIG. 3A) receives column 308, where raised portion 301a of column block 301 fits within an interior portion of column 308 (not visible in FIG. 3D). A loop portion of a clasp system on column 308 (not visible in FIG. 3D) is engaged with a hook portion of the same clasp system on column block 301, thereby securing column 308 to base 300 (one or more additional clasp systems may be provided to further secure column 308 to base 300).

At FIG. 3E, each of post covers 320, 322, and 324 are pulled over a respective one of post 308, 310, and 312.

At FIG. 3F, platform 326 is configured for coupling to posts 310 and 312. More specifically, platform blocks 328 and 330 each include a respective raised portion 328a and 330a. Raised portion 328a of platform block 328 fits within an interior portion of column 310. Likewise, raised portion 330a of platform block 330 fits within an interior portion of column 312.

Further, column 310 includes a loop portion 315a configured to be secured to hook portion 315d on platform block 328. Loop portion 315a and hook portion 315d are included in clasp system 316a. Likewise, column 312 includes a loop portion 317a configured to be secured to hook portion 317d on platform block 330. Loop portion 317a and hook portion 317d are included in clasp system 318a. Additional clasp system(s) may be provided on a side of column 310 and/or 312 not visible in FIG. 3F.

At FIG. 3G, a pet bed includes a wall system 332 (having wall sections 332a, 332b, 332c, 332d, and 332e) being secured to pet bed base 336. For example, wall system 332 is secured to pet bed base 336 by aligning a grooved portion of each of wall sections 332a, 332b, 332c, 332d, and 332e (e.g., grooved portion 333 of wall section 332c) with a corresponding portion of pet bed base 336. Wall system 332 is further secured to pet bed base 336 by engaging clasp system 334 including loop portion 334a and hook portion 334b (clasp system 334 is illustrated in an engaged configuration in FIG. 3H).

FIG. 3H illustrates the pet bed (including pet bed base 336 and wall system 332) being configured for coupling to column 308. More specifically, block 338 is aligned with column 308 such that raised portion 338a of block 338 fits within an interior portion of column 308. Clasp system 314a, including loop portion 313a on column 308 and hook portion 313d on block 338, further secures the pet bed to column 308. Another clasp system may be provided on a side of column 308 not visible in FIG. 3H.

At FIG. 3I, platform cover 342 is applied and secured to platform 326 (e.g., using Velcro® tabs or similar fastening means such as those illustrated in FIG. 3B with respect to cover 304). Additionally, pet bed cover 340 is applied and secured to the pet bed (including wall system 332 and pet bed base 336).

FIGS. 4A-4C illustrate an exemplary clasp system for use with a pet furniture system, such as clasp systems 112a, 112b, 112c, 112d, and 122 illustrated in FIGS. 1A-1H.

Referring now to FIG. 4A, loop portion 400 of a clasp system includes catch body 402, catch handle 404, and loop 410. Loop portion 400 is fastened to a portion of a pet furniture system (e.g., loop portion 122a of clasp system 122 is fastened to wall section 120e as illustrated in FIG. 1G) using fastening portion 406 and fasteners 408a and 408b (e.g., screws 408a and 408b). Thus, fasteners 408a and 408b secure loop portion 400 to a portion of a pet furniture system through fastening portion 406.

Referring now to the side view of the clasp system illustrated in FIG. 4B, loop portion 400 is illustrated in an engaged position with respect to hook portion 420. More specifically, loop 410 is “looped” around hook portion 420, and catch handle 404 is in a substantially downward position (i.e., a “locked” position). In order to disengage the clasp system, catch handle 404 may be raised from the substantially downward position illustrated in FIG. 4B such that loop 410 may be swung over hook portion 420.

Referring now to the top view of the clasp system illustrated in FIG. 4C, loop portion 400 is illustrated in an engaged (i.e., “locked”) position with respect to hook portion 420. As in FIG. 4B, loop 410 is “looped” around hook 420, and catch handle 404 is in a substantially downward position (i.e., a locked position).

As illustrated in FIG. 4C, hook portion 420 is fastened to a portion of a pet furniture system (e.g., hook portion 122b of clasp system 122 is fastened to wall section 120d as illustrated in FIG. 1G) using fasteners 422a and 422b (e.g., screws 422a and 422b).

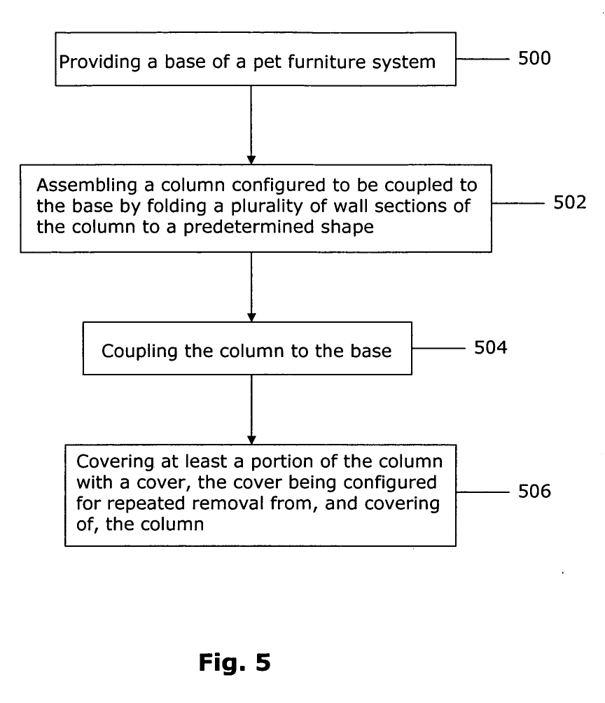

FIG. 5 is a flow diagram illustrating an exemplary method of assembling a pet furniture system. At step 500, a base of the pet furniture system is provided. For example, base 100 of a pet furniture system that is illustrated in FIG. 1A is provided. At step 502, a column configured to be coupled to the base is assembled by folding a plurality of wall sections of the column to a predetermined shape. For example, FIG. 1C illustrates column 108 being assembled by folding wall sections 110a, 110b, 110c, 110d, and 110e to a predetermined shape. At step 504, the column is coupled to the base, for example, as illustrated at FIGS. 1D-1E. At step 506, at least a portion of the column is covered with a cover, where the cover is configured for repeated removal from, and covering of, the column. For example, FIG. 1E illustrates column 108 at least partially covered by cover 114. Additional steps may optionally be included in this exemplary method of assembling a pet furniture system, as described above with respect to any of FIGS. 1A-4C.

The exemplary columns (e.g., column 108 illustrated in FIG. 1C; column 208 illustrated in FIG. 2C; and columns 308, 310, and 312 illustrated in FIG. 3C), bases (e.g., base 100 illustrated in FIG. 1A, base 200 illustrated in FIG. 2A, and base 300 illustrated in FIG. 3A), wall systems (e.g., wall system 120 illustrated in FIG. 1G, and wall system 332 illustrated in FIG. 3G), bed bases (e.g., bed base 116 illustrated in FIG. 1G, and bed base 336 illustrated in FIG. 3G), and platforms (e.g., platform 326 illustrated in FIG. 3F) may be constructed of, for example, MDF board. MDF board may be utilized because it provides a relatively low cost material that may be repetitively machined to a desired degree of accuracy. Other materials (e.g., plywood, solid wood, a polymeric material, etc) may be used for one or more of these components. For example, rubber tree wood may be used for bases which may endure occasional human foot traffic.

Certain exemplary columns (e.g., column 108) and wall systems (e.g., wall system 120) disclosed herein include wall sections that are hingedly or pivotally coupled to one another. For example, column 108 illustrated in FIG. 1C includes wall sections 110a, 110b, 110c, 110d, and 110e. Wall portion 110a is coupled to wall portion 110b, wall portion 110b is coupled to wall portion 110c, wall portion 110c is coupled to wall portion 110d, and wall portion 110e is coupled to wall portion 110a. In order to provide this hinged or pivotal coupling, a material (e.g., a fabric material) may be glued to one side of each of these wall portions. An exemplary fabric material comprises ethylene vinyl acetate emulsion (75% by weight), vinyl acetate copolymer (18% by weight), plasticizer (5% by weight), and a solvent such as toluene (2% by weight). An exemplary glue is Dynocoll 219, supplied by Dynea Co., Ltd. Such an exemplary fabric material and glue combination provides an exceptional bond to the wall sections (e.g., comprising MDF board).

Alternatively, hinges or other pivoting mechanisms may be provided between each of the wall sections.

The blocks described herein (e.g., base block 102 illustrated in FIG. 1A) may be constructed from any of a number of suitable materials, for example, wood, metal, a polymer, etc.

A number of covers are utilized in accordance with the exemplary embodiments of the present invention illustrated and described herein. For example, base cover 104, column cover 114, and bed cover 124, are illustrated in FIGS. 1A-1H. For example, these covers may include a structural backside and an exterior fabric. For example, the structural backside may comprise polyester (e.g., 800 grams per linear yard, 58-61-inch wide), and the exterior fabric may include plush acrylic pile (e.g., including fibers having a length of ten mm, and a density of 800 grams per yard). This acrylic pile may be provided with an electric charge (e.g., a positive charge or a negative charge) that is substantially equivalent to the static charge of pet hair (e.g., cat hair) such that while a pet is using the furniture (including the cover), the pet hair is repelled from adhering to the fabric.

As described herein the covers may be removed from the corresponding structural components of the pet furniture system. As such, if the covers are worn, they may be easily replaced without replacing the entire pet furniture system. Further, the covers may be removed and machine washed as desired. Thus, an efficient method of cleaning pet furniture covers, which reduces the potential for allergic reactions related to pet hair and/or pet dander, is provided.

Further, although the pet furniture covers have primarily have been described as including fasteners for securing a respective cover to a respective structural component of a pet furniture system (e.g., Velcro® tabs), certain of the covers may be sized and shaped such that they are secured to the respective structural component simply through their application thereto. For example, a platform cover may be tailored to slip over a platform with sufficient tension applied thereto such that no distinct mechanism is needed to secure the cover to the platform.

According to the various exemplary embodiments of the present invention disclosed herein, pet furniture systems are provided that may be packaged, stored, and shipped while occupying a reduced amount of space in comparison to conventional pet furniture systems. Further, the pet furniture may be easily assembled without the use of tools (e.g., because of the use of clasp systems in assembling certain exemplary components of a pet furniture system).

Further, the certain exemplary embodiments of the pet furniture disclosed and contemplated herein are modular in nature, and as such, combination products may be offered where the consumer may switch one or more components to change the style of the pet furniture. For example, the pet furniture system illustrated in FIGS. 1A-1H could be sold with block 214 and cover 216 of the pet furniture system illustrated in FIGS. 2E-2F. By providing these two additional components, the consumer is able to construct a pet furniture system as illustrated in either of FIG. 1H or FIG. 2G. Therefore, the consumer is able to maintain the interest of a pet in the pet furniture system by occasionally switching between the two or more configurations.

As described herein, the structural members of the furniture systems may be comprised, for example, MDF board, rubber tree wood, etc., as opposed to cardboard. Thus, the furniture may be used over a more substantial length of time. Further still, because the covers may be replaced when worn, or washed when soiled, the wasteful disposal of an entire furniture system solely based upon worn or soiled covers may be substantially prevented.

Although the mechanisms disclosed herein for securing various components of the various pet furniture systems together has primarily related to clasping systems that include a loop portion and a hook portion, the present invention is not limited thereto. While such clasp systems provide for efficient assembly of the systems without the use of tools, other clasping systems and mechanisms for securing the various components together are also contemplated.

Although the present invention has been described primarily with reference to cats, it is not limited thereto. Rather, the inventive concepts may be applied to, for example, dog furniture, rodent furniture, and furniture for any of a number of other household pets.

Although the invention is illustrated and described herein with reference to specific embodiments, the invention is not intended to be limited to the details shown. Rather, various modifications may be made in the details within the scope and range of equivalents of the claims and without departing from the invention.

1. A pet furniture system, comprising:
a base;
a column configured to be coupled to said base, said column comprising a plurality of wall sections to be folded into an assembled position to assemble said column into a predetermined shape and to be unfolded into a disassembled position to disassemble said column, each of the wall sections having mating surfaces to produce the predetermined shape of the assembled column; and
a cover having at least a portion that circumferentially surrounds said column, said cover being configured for repeated removal from, and covering of, said column, wherein when the column is in the assembled position, the cover reinforces the plurality of wall sections such that corresponding mating surfaces of respective wall sections contact to maintain the predetermined shape of the assembled column.

2. The pet furniture system of claim 1, further comprising:
at least one clasp system for coupling said column to said base, said clasp system including a loop portion coupled to one of said column and said base, and a hook portion coupled to the other of said column and said base, said loop portion being configured to engage said hook portion.

3. The pet furniture system of claim 1, further comprising:
a clasp system for securing said column in an assembled position, said clasp system including a loop portion coupled to one of said wall sections of said column, and a hook portion coupled to another of said wall sections of said column, said loop portion being configured to engage said hook portion.

4. The pet furniture system of claim 1, further comprising:
fabric on a surface of each of the wall sections.

5. The pet furniture system of claim 1, wherein at least a portion of said cover is made of a material configured to accept an electric charge.

6. The pet furniture system of claim 1, further comprising:
a column block coupled to said base for receiving said column, said column block including a raised portion configured to fit within an interior of said column upon said column block receiving said column.

7. The pet furniture system of claim 6, further comprising:
at least one clasp system for coupling said column to said column block, said clasp system including a loop portion coupled to one of said column and said column block, and a hook portion coupled to the other of said column and said column block, said loop portion being configured to engage said hook portion.

8. The pet furniture system of claim 1, further comprising:
a base cover for at least partially covering said base, said base cover being configured for repeated removal from, and covering of, said base.

9. The pet furniture system of claim 8, wherein at least a portion of said base cover is made of a material configured to accept an electric charge.

10. The pet furniture system of claim 1, wherein the column includes first and second ends, the pet furniture system further comprising:
a pet bed for coupling to the first end of said column, wherein the second end of said column is coupled to said base.

11. The pet furniture system of claim 10, wherein said pet bed includes a bed base for coupling to said first end of said column, and a wall system for at least partially surrounding said bed base, said wall system comprising a plurality of wall sections to be folded to assemble said wall system, and to be unfolded to disassemble said wall system.

12. The pet furniture system of claim 11, further comprising:
a clasp system for securing said wall system in an assembled position, said clasp system including a loop portion coupled to one of said wall sections of said wall system, and a hook portion coupled to another of said wall sections of said wall system, said loop portion being configured to engage said hook portion.

13. The pet furniture system of claim 10, further comprising:
a pet bed cover for at least partially covering said pet bed, said pet bed cover being configured for repeated removal from, and covering of, said pet bed.

14. The pet furniture system of claim 13, wherein at least a portion of said pet bed cover is made of a material configured to accept an electric charge.

15. The pet furniture system of claim 1, wherein the column includes an open end and another end, the pet furniture system further comprising:
a column cap for covering the open end of said column, said open end of said column being opposite the other end of said column coupled to said base; and
at least one clasp system for coupling said column cap to said column, said clasp system including a loop portion coupled to one of said column and said column cap, and a hook portion coupled to the other of said column and said column cap, said loop portion being configured to engage said hook portion.

16. The pet furniture system of claim 1, further comprising:
a plurality of said column, and a corresponding plurality of said cover.

17. The pet furniture system of claim 16, further comprising:
a platform coupled to at least one of said columns, said platform including a platform block configured to be received by an open end of said at least one of said columns, said open end of said column being opposite an end of said column coupled to said base.

18. The pet furniture system of claim 17, further comprising:
at least one clasp system for coupling said platform block to said column, said clasp system including a loop portion coupled to one of said column and said platform block, and a hook portion coupled to the other of said column and said platform block, said loop portion being configured to engage said hook portion.

19. The pet furniture system of claim 17, further comprising:
a platform cover for at least partially covering said platform, said platform cover being configured for repeated removal from, and covering of, said platform.

20. The pet furniture system of claim 19, wherein at least a portion of said platform cover is made of a material configured to accept an electric charge.

21. A method of assembling a pet furniture system having a base, a column and a cover, said method comprising the steps of:
preassembling said column having a plurality of wall sections, and at least one linking layer by linking respective wall sections to one another via the at least one linking layer, each of the wall sections having mating surfaces to produce a predetermined shape of the assembled column; and;
assembling a column configured to be coupled to the base by folding the plurality of wall sections of the column to the predetermined shape; and
coupling the column to the base; and
circumferentially surrounding at least a portion of the column with a cover, the cover being configured for repeated removal from, and covering of, the column to reinforce the plurality of wall sections such that corresponding mating surfaces of respective wall sections contact to maintain the predetermined shape of the assembled column.

22. A pet furniture system comprising:
a base;
a column configured to be coupled to said base, said column comprising a plurality of wall sections, and at least one linking layer for linking respective wall sections to one another, the plurality of wall sections to be folded to assemble said column in a folded position in a predetermined shape, as an assembled column and to be unfolded to disassemble said column in an unfolded position, as a disassembled column such that in the unfolded position the disassembled column is substantially flat; and
a cover for at least circumferentially surrounds said column, said cover being configured for repeated removal from, and covering of, said column such that in the folded position the assembled column is reinforced by the cover to maintain the predetermined shape of the assembled column.
